(19) United States
(12) Patent Application Publication
(10) Pub. No.: US 2007/0003267 A1
(43) Pub. Date: Jan. 4, 2007

(54) Image capture apparatus with auto focus function

(75) Inventor: Atsushi Shibutani, Tokorozawa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/471,300

(22) Filed: Jun. 20, 2006

(30) Foreign Application Priority Data
Jun. 29, 2005 (JP) 2005-190279

(51) Int. Cl. G03B 13/34

(52) U.S. Cl. 396/123

(57) ABSTRACT

An image capture apparatus comprising an image capture unit which captures an image of a subject, a first focus control unit which performs a predetermined focus operation for the subject, a first image recognition unit which, after the predetermined focus operation by the first focus control unit, recognizes a position of the subject based on image data obtained by the image capture unit, and a second focus control unit which moves a focus lens to a focusing lens position where an image at the position of the subject recognized by the first image recognition unit comes into focus.

### CROSS-REFERENCE TO RELATED APPLICATIONS

This application is based upon and claims the benefit of priority from prior Japanese Patent Application No. 2005-190279, filed Jun. 29, 2005, the entire contents of which are incorporated herein by reference.

### BACKGROUND OF THE INVENTION

1. Field of the Invention

The present invention relates to an image capture apparatus having an auto focus function and an auto focus control method which are applicable to a digital camera.

2. Description of the Related Art

In digital cameras, there is an auto focus function for bringing a captured subject into focus for obtaining a preferable image.

However, in a conventional auto focus (AF) function, there has been a problem that focusing is made on not a figure intended to be captured but another subject such as a background landscape, and focusing is not brought on a subject intended to be captured.

In order to solve this problem, there has been provided an AF process in which the face of a subject is recognized by an image recognizing process, and auto focusing is performed such that the recognized face comes into focus (for example, Jpn. Pat. Appln. KOKAI Publication No. 2004-317699).

### BRIEF DESCRIPTION OF THE SEVERAL VIEWS OF THE DRAWINGS

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing a digital camera according to an embodiment of the present invention;

FIG. 2 is a flowchart showing an operation of the digital camera according to the embodiment; and

FIG. 3 shows a through image and a focus frame appearance displayed after a first image recognizing process.

### DETAILED DESCRIPTION OF THE INVENTION

An embodiment of an image capture apparatus and an auto focusing method according to the present invention will now be described with reference to the accompanying drawings. In the following, a digital camera is described as an example of the image capture apparatus.

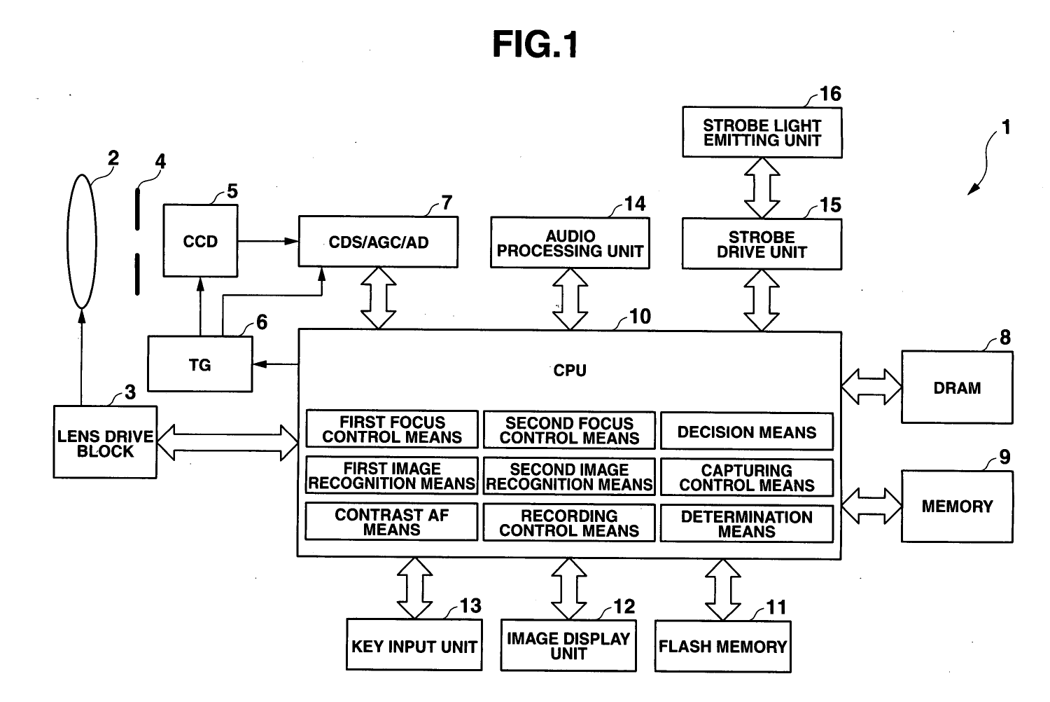

Configuration of Digital Camera FIG. 1 is a block diagram showing an electrical schematic configuration of a digital camera 1 that realizes an image capture apparatus according to an embodiment of the present invention.

The digital camera 1 includes a capturing lens 2, a lens drive block 3, an diaphragm-shutter 4, a CCD (charge coupled device) 5, a TG (timing generator) 6, a unit circuit 7, a dynamic random access memory (DRAM) 8, a memory 9, a central processing unit (CPU) 10, a flash memory 11, an image display unit 12, a key input unit 13, an audio processing unit 14, a strobe drive unit 15, and a strobe light emitting unit 16.

The capturing lens 2 includes a focus lens and a zoom lens which are not shown, and the lens drive block 3 is connected thereto. The lens drive block 3 includes a focus motor and a zoom motor for driving the focus lens and zoom lens (not shown) in the optical axis direction, respectively, and a focus motor driver and a zoom motor driver for driving the focus motor and zoom motor in the optical axis direction, respectively, according to control signals from the CPU 10.

The diaphragm-shutter 4 includes a drive circuit (not shown), and the drive circuit drives the diaphragm-shutter 4 according to control signals from the CPU 10. The diaphragm-shutter 4 functions as a diaphragm and a shutter.

The diaphragm means a mechanism that controls the amount of light coming in from the capturing lens 2, and the shutter means a mechanism that controls the time for supplying light to the CCD 5. The time for supplying light to the CCD 5 changes with the speed for opening and closing the shutter (shutter speed). Exposure can be determined by the diaphragm and the shutter speed.

The CCD 5 functions as image capture means, and converts light of a subject projected via the capturing lens 2 and the diaphragm-shutter 4 into an electric signal to output the signal as an image signal to the unit circuit 7. The CCD 5 drives according to a timing signal of a predetermined frequency generated by the TG 6. The unit circuit 7 is connected to the TG 6.

The unit circuit 7 includes a correlated double sampling (CDS) circuit that performs correlated double sampling of the image signal output from the CCD 5 to hold the signal, an automatic gain control (AGC) circuit that performs an automatic gain control of the image signal after the sampling, and an A/D converter that converts the analog image signal after the automatic gain control into a digital signal. The image signal of the CCD 5 is sent as a digital signal to the CPU 10 via the unit circuit 7.

The CPU 10 is a one-chip microcomputer that has functions of performing image processes (pixel interpolation process, gamma correction, generation of brightness color difference signals, white balance process, exposure correction process and the likes) of image data sent from the unit circuit 7, compression and expansion of image data (for example, compression and expansion in JPEG format and MPEG format), AF process (AF process by a contrast detection method and AF process by pan focus), image recognition process and the like, and that controls the respective units of the digital camera 1.

The memory 9 stores a control program necessary for the respective units of the CPU 10, namely, a program necessary for various controls including AE and AF etc., and necessary data. The CPU 10 makes its operations according to the program, thereby functioning as first and second focus control means, decision means, first and second image recognition means, capturing control means, recording control means, contrast AF means, and determination means.

The DRAM 8 is used as a buffer memory for temporarily storing image data that is captured by the CCD 5 and then sent to the CPU 10, and also used as a working memory of the CPU 10.

The flash memory 11 functions as recording means, and is a recording medium for storing image data captured by the CCD 5 and the like.

The image display unit 12 includes a color LCD and a drive circuit thereof. In a standby state, the image display unit 12 displays a subject captured by the CCD 5 as a through image, and when reproducing a recorded image, it displays a recorded image read from the flash memory 11 for storage to be expanded.

The key input unit 13 includes a shutter button that enables a halfway press operation and a full press operation, the shutter button functioning as first and second instruction means, and a plurality of operation keys such as a zoom continuous shooting key, a cross key and a set key. The key input unit 13 outputs operation signals corresponding to user's key operations to the CPU 10.

The audio processing unit 14 includes a built-in microphone, an amplifier, an A/D converter, a D/A converter, an amplifier, a built-in speaker and the like. At the moment of capturing images with audio, the audio processing unit 14 converts audio input into the built-in microphone into a digital signal and sends the signal to the CPU 10. The audio data sent to the CPU 10 is stored sequentially into the buffer memory (DRAM 8), and recorded into the flash memory 11 together with the image data captured by the CCD 5.

When reproducing images with audio, the audio processing unit 14 reproduces audio and the like based on audio data attached to each item of image data through the built-in speaker.

The strobe drive unit 15 drives the strobe light emitting unit 16 so as to emit strobe light according to the control signal from the CPU 10, so that the strobe light emitting unit 16 emits the strobe light. The CPU 10 determines whether a capturing scene is dark or not by a photometry circuit (not shown). When it is determined that the capturing scene is dark and that capturing is to be performed (when the shutter button is pressed), the CPU 10 sends a control signal to the strobe drive unit 15.

Operation of Digital Camera 1

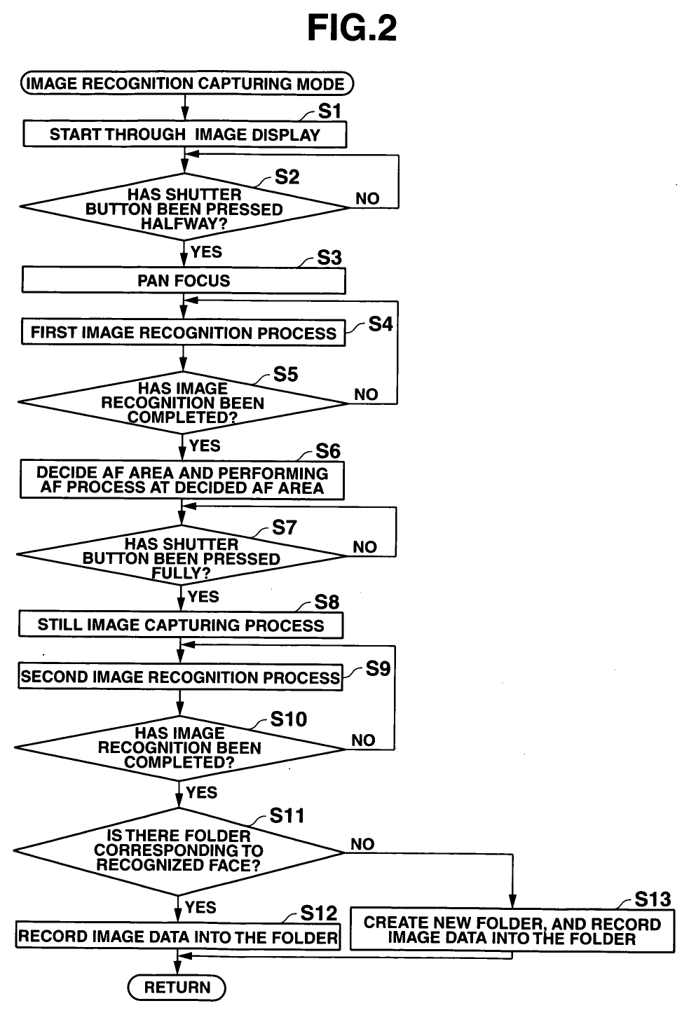

An operation of the digital camera 1 according to the embodiment will be explained with reference to the flowchart in FIG. 2.

When a user operates the key input unit 13 and sets an image recognition capturing mode, the CPU 10 starts so-called through image display. In the through image display, capturing a subject by the CCD 5 is started, image process is performed with reference to image data of the subject captured by the CCD 5 to store the processed image into the buffer memory (DRAM 8), and an image of the stored image data is displayed on the image display unit 12 (step S1).

Next, the CPU 10 determines whether the user has halfway pressed the shutter button or not (step S2). This determination is made by determining whether or not an operation signal corresponding to the shutter button halfway press operation has been sent from the key input unit 13.

If the CPU 10 determines that the shutter button has been pressed halfway in step S2, the CPU 10 performs a focus process by pan focus (step S3). More specifically, the CPU 10 moves the focus lens to a preset fixed focusing lens position.

Then, the CPU 10 performs a first image recognition process (step S4). The first image recognition process simply means a process for recognizing at which position in the image of the captured image data the face of a person is. The CPU 10 compares and collates face characteristic data stored in advance and the captured image data, thereby checking whether or not there is image data of the person's face in the captured image data. When it is determined that there is image data of the person's face, the CPU 10 recognizes at which position the face image data is. However, recognition of presence/absence of the face and the recognition of the face position may be performed at the same time.

Meanwhile, in the first image recognition process, it is enough that the position of the person's face in the image of the captured image data is recognized. Accordingly, image recognition at the level where the person's face outline, eyes and mouth, and other rough characteristics can be recognized is sufficient. Namely, there is no need to concretely recognize whose face the face is at all.

When the first image recognition process is performed, the CPU 10 determines whether the image recognition has been completed or not (step S5). More specifically, if it is recognized at which position of the image of the captured image data the person's face is, the CPU 10 determines that the image recognition has been completed.

If it is determined that the image recognition has not been completed in step S5, the procedure goes back to step S4. Namely, the first image recognition process is performed until it is determined that the image recognition has been completed.

On the other hand, if it is recognized that the image recognition has been completed in step S5, an AF area is decided on the face position of the recognized subject, and an AF process is performed (step S6). Herein, since an AF process in accordance with a contrast detection method is performed, the focus lens is moved to the lens position where a contrast value of the decided AF area becomes highest. In the AF process in accordance with the contrast detection method, the focus lens is moved, the contrast of the CCD 5 during the movement is converted into an electric signal, and the waveform thereof is interpreted, namely, the focus lens is set to the lens position where the high-frequency component becomes largest, so that focusing is made.

Meanwhile, in order to let the user know the decided AF area, a focus frame is displayed on the image display unit 12. The focus frame shows the AF area.

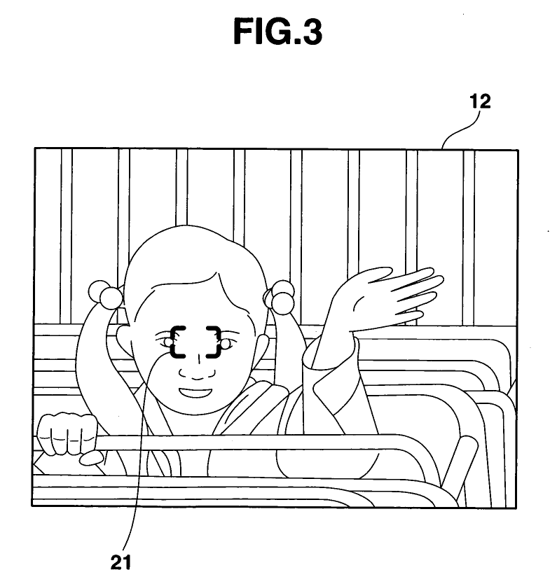

FIG. 3 shows a through image displayed after the first image recognition process and the appearance of the focus frame. An image of a girl (herein called “A”) displayed on the image display unit 12 or the like is image data imaged by the CCD 5, and reference number 21 denotes the focus frame.

Next, the CPU 10 determines whether or not the shutter button has been fully pressed by its user (step S7). This determination is made by determining whether or not an operation signal corresponding to the shutter button full press operation has been sent from the key input unit 13.

If it is determined that the shutter button is not fully pressed in step S7, the procedure remains in step S7 until it is fully pressed. If it is determined that the shutter button is fully pressed in step S7, the CPU 10 performs a still image capturing process (step S8). Namely, the CPU 10 causes the CCD 2 to output pixel signals of even number lines and pixel signals of odd number lines in one screen at a relatively long output timing, and takes data of all the pixels into the buffer memory (DRAM 8). Herein, it is supposed that, in the state shown in FIG. 3, the user has fully pressed the shutter button.

Subsequently, the CPU 10 performs a second image recognition process to the captured image data obtained by the still image capturing process (step S9). The second recognition process, in a brief explanation, has higher precision than that of the first image recognition process, and is a process in which not only it is recognized whether or not there is a person's face in the image simply, but also it is concretely recognized whose face the subject's face is. For example, skin color, hair color, eye position, nose position, mouth position and the like are recognized, and the positional relations thereof are also recognized. Then, these are quantified and numeric value data are calculated, and the data are compared and collated with numeric value data recognized and calculated from face images of a predetermined person stored in advance, whereby the person is identified. Meanwhile, there are already other well-known image recognition methods, and their detailed explanations are omitted.

When the second image recognition process is performed, the CPU 10 determines whether the image has been recognized or not (step S10). Namely, it determines whether whose face has been recognized concretely or not.

If it is determined the image has not been recognized in step S10, the procedure goes back to the step S9. That is, the second image recognition process is performed until it is determined that the image has been recognized.

On the other hand, if it is determined the image has been recognized in step S10, the CPU 10 determines whether or not there is a folder corresponding to the recognized face (person) (step S11). More specifically, the CPU 10 determines whether or not there is a folder associated with the numeric value data of the face in the flash memory 11.

Herein, since it is recognized to be the face of “A”, it is determined whether there is a folder corresponding to “A” or not. Namely, when the folder of “A” (folder associated with the numeric value data of the face of “A”) has been created in the flash memory 11, there is the folder of “A”, and thus, the CPU 10 determines that there is a folder corresponding to the recognized face.

When the CPU 10 determines that there is the folder corresponding to the recognized face, namely, when the CPU 10 determines there is the folder corresponding to the face of “A” in step S11, the CPU 10 records the captured image data into the folder of “A” in the flash memory 11 in step S12.

On the other hand, when the CPU 10 determines that there is no folder corresponding to the recognized face, namely, when the CPU 10 determines there is no folder corresponding to the face of “A” in step S11, the CPU 10 creates a new folder associated with the numeric value data of the face of “A”, and records the captured image data into the folder in step S13.

As explained above, in the present embodiment, when the user halfway presses the shutter button in the image recognition capturing mode, the first image recognition process is performed after the focus process by pan focus is performed. Accordingly, it is possible to recognize where the face of the subject is at high precision.

Further, the first image recognition process is a simple process at the level as to recognize whether there is a person's face in an image of a captured image data, and where a person's face is if there is one, and therefore, the process can be performed quickly.

Furthermore, the AF area is decided at the position of the face recognized by the image recognition process, and the AF process is performed in accordance with the contrast detection method at the decided AF area. Consequently, it is possible to focus on the face of the subject at high precision.

Moreover, since the second image recognition process is performed to the captured image data captured after focusing on the face of the subject, it is possible to recognize who the subject is at high precision.

Further, since image data is recorded into the folder corresponding to the recognized person after the second image recognition process, it is possible to search for captured image data quickly and simply. In addition, even if there is no folder corresponding to the recognized person after the second image recognition process, a folder corresponding to the recognized person is created and recorded. Accordingly, it is possible to search for captured image data quickly and simply.

Meanwhile, in the above embodiment, the focus lens is moved to the preset fixed focusing lens position when pan focus is performed (step S3 in FIG. 2). However, the focus lens may be moved to a lens position set arbitrarily by the user, or, while a through image is displayed before the shutter button halfway press operation (step S1 to step S2), a capturing scene (outdoor or indoor, diaphragm released or not, optical zoom magnification and the like) may be determined based on the through image, and the focus lens may be moved to the fixed focusing lens position corresponding to the capturing scene determined before the shutter button halfway press operation.

Further, in the place of pan focus, the AF process in accordance with the contrast detecting method may be performed by the search interval (focus lens movement range), search interval (sampling interval) or the like corresponding to the determined capturing scene. In this case, in order to perform the AF process quickly, the search range is narrowed and the search interval is widened than those in the AF process by the contrast detection method in step S6 in FIG. 2.

Furthermore, without determining the capturing scene, a simple AF process may be performed wherein the search range is narrowed and the search interval is widened than those in the AF process by the contrast detection method in step S6 in FIG. 2.

Namely, as the AF process in step S3 in FIG. 2, anything may be employed so long as it is a focus process for focusing on a subject at a level not causing troubles to the first image recognition process (this focus process is called a simple focus process).

Moreover, after the shutter button halfway press operation, a simple focus operation is performed, and then, the first image recognition process is performed. However, while a through image is displayed before the shutter button halfway press operation or during the recovery to the through image display after the still image capturing process, a simple focus operation may be performed. As a consequence, it is possible to hasten the process after pressing the shutter button halfway.

While the through image is displayed before the shutter button halfway press operation, a simple focus operation may be performed, and the first image recognition process may be performed. Consequently, after the shutter button halfway press operation, only the AF process in accordance with the contrast detection method and the second image recognition process have to be performed. Accordingly, it is possible to further hasten the process after pressing the shutter button halfway.

If there is no folder corresponding to the person recognized by the second image recognition process, a folder corresponding to the person is newly created, and captured image data is recorded into the folder. However, captured image data may be recorded as it is without creating a folder. This is because, if there is no folder corresponding to the recognized person, it is considered that the person is not one to be captured so frequently.

In addition, if there are two or more folders corresponding to the person recognized by the second image recognition process, data may be recorded into all the folders. For example, when papa, mama and “A” are captured in captured image data, the captured image data are recorded into the folder corresponding to papa, the folder corresponding to mama, and the folder corresponding to “A”. It is to be noted that the number of captured image data to be recorded is one, and information belonging to the papa's folder, mama's folder and A's folder must be recorded to the header of the captured image data.

Captured image data is recorded into the folder corresponding to the person recognized by the second image recognition process. However, information showing the person recognized in association with captured image data may be recorded simply.

Further, a person's face is recognized in the first and second image recognition processes. However, the present invention is not limited thereto, and anything of subjects, for example, a car, an animal, a plant and the like may be recognized.

Furthermore, captured image data are classified and recorded according to the recognition result by the second image recognition process. However, the recognition result by the second image recognition process may be used for other applications.

Moreover, the digital camera 1 is not limited to the above embodiment. It may be any device that can capture a subject, such as a cellular phone with camera, a personal digital assistance (PDA) with camera, a personal computer with camera, a IC recorder with camera, or a digital video camera.

What is claimed is:

1. An image capture apparatus comprising:
an image capture unit which captures an image of a subject;
a first focus control unit which performs a predetermined focus operation for the subject;
a first image recognition unit which, after the predetermined focus operation by the first focus control unit, recognizes a position of the subject based on image data obtained by the image capture unit; and
a second focus control unit which moves a focus lens to a focusing lens position where an image at the position of the subject recognized by the first image recognition unit comes into focus.

2. An image capture apparatus according to claim 1, wherein the first focus control unit moves the focus lens to a fixed lens position, thereby performing the focus operation for the subject.

3. An image capture apparatus according to claim 1, further comprising:
a decision unit which decides a capturing scene, and wherein
the first focus control unit moves the focus lens to a lens position corresponding to the capturing scene decided by the decision unit.

4. An image capture apparatus according to claim 1, wherein the first focus control unit includes:
a contrast auto focus unit which changes the lens position of the focus lens, and detects auto focus evaluation values of the image data obtained by the image capture unit, thereby moving the focus lens to the focusing lens position based on the detected auto focus evaluation values.

5. An image capture apparatus according to claim 4, further comprising:
a decision unit which decides a capturing scene, and wherein
the contrast auto focus unit changes the lens position of the focus lens in a search range and/or at a search interval corresponding to the capturing scene decided by the decision unit, thereby detecting auto focus evaluation values of the image data obtained by the image capture unit, and moving the focus lens to the focusing lens position.

6. An image capture apparatus according to claim 1, wherein the second focus control unit changes the lens position of the focus lens, and detects auto focus evaluation values of the image data corresponding to the position of the subject recognized by the first image recognition unit among the image data obtained by the image capture unit, thereby moving the focus lens to the focusing lens position based on the detected auto focus evaluation values.

7. An image capture apparatus according to claim 1, wherein the predetermined focus operation performed by the first focus control unit is simpler or quicker than a focus operation performed by the second focus control unit.

8. An image capture apparatus according to claim 1, further comprising:
a first instruction unit which instructs preparation for capturing, and wherein
the first focus control unit performs the predetermined focus operation for the subject when there is an instruction of preparation for capturing by the first instruction unit,
when there is an instruction of preparation for capturing by the first instruction unit, the first image recognition unit recognizes the position of the subject based on the image data obtained by the image capture unit after the focus operation has been performed by the first focus control unit, and
when there is an instruction of preparation for capturing by the first instruction unit, the second focus control unit moves the focus lens to the focusing lens position such that the image at the position of the subject recognized by the first image recognition unit comes into focus.

9. An image capture apparatus according to claim 1, further comprising:
a second image recognition unit which recognizes a kind of the subject based on the image data obtained by the image capture unit, and wherein
the second image recognition unit recognizes the kind of the subject of the image data obtained by the image capture unit after the focus operation.

10. An image capture apparatus according to claim 9, wherein an image recognition performed by the first image recognition unit is simpler than an image recognition performed by the second image recognition unit.

11. An image capture apparatus according to claim 1, further comprising:
a second instruction unit which instructs preparation for capturing; and
a capturing control unit which controls still image capturing of the subject by the image capture unit, and wherein
the capturing control unit controls the still image capturing of the subject by the image capture unit when there is an instruction of capturing by the second instruction unit after the focus operation has bee performed by the second focus control unit, and
the second image recognition unit recognizes a kind of the subject based on the image data obtained by the still image capturing controlled by the capturing control unit.

12. An image capture apparatus according to claim 9, further comprising:
a recording control unit which records the image data obtained by the image capture unit into recording unit, and wherein
the recording control unit classifies and records the image data obtained by the image capture unit based on the kind of the subject recognized by the second image recognition unit.

13. An image capture apparatus according to claim 12, wherein the recording control unit records the image data obtained by the image capture unit into a folder corresponding to the subject recognized by the second image recognition unit,
further comprising a determination unit which determines whether there is a folder corresponding to the kind of the subject recognized by the second image recognition unit in the recording unit, and
wherein the recording control unit records the recognized image data obtained by the image capture unit into the folder when the determination unit determines that there is a folder corresponding to the kind of the subject recognized.

14. An image capture apparatus according to claim 13, wherein, when the determination unit determines that there is no folder corresponding to the kind of the recognized subject, the recording control unit newly creates a folder corresponding to the kind of the recognized subject, and records the recognized image data obtained by the image capture unit into the created folder.

15. An image capture apparatus according to claim 13, wherein, when the determination unit determines that there is no folder corresponding to the kind of the recognized subject, the recording control unit records the recognized image data obtained by the image capture unit into the recording medium.

16. An auto focus control method comprising:
a first focus control step which performs a predetermined focus operation for a subject;
an image capture step which captures an image of the subject after the predetermined focus operation performed by the first focus control step;
an image recognition step which recognizes a position of the subject based on image data obtained by the image capture step; and
a second focus control step which moves a focus lens to a focusing lens position where an image at the position of the subject recognized by the image recognition step comes into focus.

17. A computer program product configured to store program instructions for execution on a computer system enabling the computer system to perform:
a first focus control process for performing a predetermined focus operation for a subject;
an image capture process for capturing an image of the subject after the predetermined focus operation performed by the first focus control process;
an image recognition process for recognizing a position of the subject based on image data obtained by the image capture process; and
a second focus control process for moving a focus lens to a focusing lens position where an image at the position of the subject recognized by the image recognition process comes into focus.
